(19) United States
(12) Patent Application Publication
(10) Pub. No.: US 2024/0008504 A1
(43) Pub. Date: Jan. 11, 2024

(54) POWDERED OIL BASED ON OLESOME EMUSION AND PREPARATION METHOD AND APPLICATION THEREOF

(71) Applicant: Sericultural & Agri-Food Research Institute Guangdong Academy of Agricultural Sciences, Guangzhou City (CN)

(72) Inventors: Zhihao ZHAO, Guangzhou City (CN); Mingwei ZHANG, Guangzhou City (CN); Yuanyuan DENG, Guangzhou City (CN); Pengfei ZHOU, Guangzhou City (CN); Zhencheng WEI, Guangzhou City (CN); Yan ZHANG, Guangzhou City (CN); Xiaojun TANG, Guangzhou City (CN); Guang LIU, Guangzhou City (CN); Ping LI, Guangzhou City (CN)

(21) Appl. No.: 18/133,724

(22) Filed: Apr. 12, 2023

(30) Foreign Application Priority Data
Jul. 5, 2022 (CN) 202210792693.7

(51) Int. Cl. A23D 9/05; A23D 9/007

(52) U.S. Cl. CPC A23D 9/05; A23D 9/007

(57) ABSTRACT

The present invention discloses powdered oil based on an olesome emusion and a preparation method and an application thereof. The preparation method includes the following steps: preparation of olesome emulsion of an oil stock, addition of a wall material and spray drying. The preparation method for the powdered oil provided by the present invention is based on an olesome emulsion system; and compared with the traditional preparation process for the powdered oil, the preparation method has many advantages that the prepared olesome emulsion does not contain hydrogenated vegetable oil and an exogenous emulsifier, is high in content of active oil accompaniments, and has an embedding rate close to 100 percent, a low production cost, strong storage stability and a certain natural oil stock flavor. The powdered oil may replace the traditional powdered oil to prepare soluble coffee, a solid beverage, milky tea and other brewed products, is widely applied, is good in quality of a product and has high actual application and application values.

### TECHNICAL FIELD

The present invention relates to the technical field of food processing, in particular to powdered oil based on an olesome emusion and a preparation method and an application thereof.

### BACKGROUND

Powdered oil is a powdered or fine particulate oil product prepared by a special processing technology with oil as a main raw material and an embedding medium, an emulsifier, a thickening stabilizer and the like as auxiliary materials, and is a generic term of microencapsulated oil products. Liquid raw oil is processed into the powdered oil, which has the advantages of convenience in use, easiness in transportation, long shelf life and the like, and is widely used for processing dairy products, beverages, pastries, cold dishes, cooked wheaten foods, candies, meat products and other products.

Traditional powdered oil is mainly processed by a microencapsulation technology. The main process includes: preparation of an oil phase: adding an oil-soluble component to raw oil for uniform mixing; preparation of an aqueous phase: adding one or more of raw wall materials to water for uniform mixing and dissolution; emulsification with homogenizing: mixing the oil phase with the aqueous phase, and adding an emulsifier for stirring and homogenizing to form an oil-in-water emulsion; and spraying and drying: spraying and drying the emulsion to obtain finely powdered or fine particulate powdered oil. The preparation process is complex.

An olesome is a subcellular organelle for plant cells storing oil; its interior liquid matrix is triglyceride; and the periphery of the olesome is covered with a membrane structure composed of a layer of phospholipids and proteins embedded therein. The olesome is composed of natural lipids and proteins, is an emulsion in a natural form, may be completely digested and absorbed by a gastrointestinal tract and has the advantages of greenness, safety, excellent emulsifying property and strong stability. Therefore, the olesome has a big application potential in the fields of foods, cosmetics and the like. The olesome can keep the system stable without the emulsifier, and has remarkable advantages in the aspect of preparing the powdered oil. For development of the olesome, it generally requires to extract and prepare a pasty crude olesome extract from an olesome emulsion first, or extract the crude olesome extract from the oil emulsion and then wash the crude olesome extract to obtain a purer olesome extract. Such development is complex in process and high in cost.

Aiming to the above problem, how to use the olesome emulsion itself to directly prepare the powdered oil is a problem to be urgently solved by the those skilled in the art.

### SUMMARY

In view of this, the present invention provides powdered oil based on an olesome emusion and a preparation method and an application thereof. The powdered oil is prepared by directly using an olesome emulsion as a liquid matrix, adding a certain amount of wall material and conducting spraying and drying, without separation of an olesome extract.

To achieve the above objective, the present invention employs the following technical solution:

First, the present invention provides a preparation method for powdered oil based on an olesome emusion. The preparation method includes the following steps:
(1) preparation of the olesome emulsion of an oil stock: soaking the oil stock subjected to impurity removal and cleaning into water according to a solid-liquid ratio of 1:(1-12) g/mL, and conducting crushing, pulping and residue removal with filtering to obtain the olesome emulsion of the oil stock;
(2) addition of a wall material in the olesome emulsion: adding the wall material to the olesome emulsion prepared in step (1) to make a mass ratio of the oil to the wall material in the system be 2:(1-18) and a content of a dry matter be 10-50 wt %; and
(3) preparation of powdered oil with spraying and drying: stirring and homogenizing the olesome emulsion, in which the wall material is added, in step (2), then conducting spraying and drying to prepare the powdered oil.

Preferably, the oil stock in step (1) is one or more of peanuts, soybeans, rapeseeds, sunflower seeds, sesames, linseeds, Camellia oleifera seeds, rice bran, walnuts, almonds and alga.

Preferably, a pulping fineness in step (1) is smaller than or equal to 0.5 mm.

Preferably, the wall material in step (2) is one or more of modified starch, maltodextrin, cyclodextrin, casein, a soy protein isolate, a whey protein, gelatin, Arabic gum and sodium alginate.

Preferably, the wall material in step (2) is dry powder, a solution, a paste or gel.

Preferably, the homogenizing used in step (3) is one or a combination of shear homogenizing, microfluidizing, homogenizing with a colloid mill or high-pressure homogenizing.

Further, a rotating speed for the shear homogenizing is 1000-11000 rpm, a pressure for the microfluidizing is 100-2500 bar; a gap between a rotor and a stator of the colloid mill is 0.05-0.2 mm; and a pressure for the high-pressure homogenizing is 100-2500 bar.

Preferably, for spraying and drying in step (3), an inlet air temperature is 120-190□, and an outlet air temperature is 60-90□.

The present invention further provides powdered oil prepared with the preparation method described in the above technical solution.

In addition, the present invention further provides an application of the powdered oil prepared with the preparation method described in the above technical solution, i.e. in brewed foods, a beverage, a confectionery product, a bakery product, a dairy product and a condiment. The powdered oil provides nutrients such as fats, proteins and saccharides to the food itself and endows a product with a certain taste and flavor.

It can be known from the technical solution, compared with the prior art, that the powdered oil based on the olesome emusion and a preparation method and an application thereof provided by the present invention have the following beneficial effects:

The preparation method for the powdered oil provided by the present invention is based on a stable natural olesome olesome emulsion system; the powdered oil does not contain hydrogenated vegetable oil and has no need for addition of an exogenous emulsifier; in the preparation process, there is no need for preparing the olesome extract from an oil stock, thereby simplifying the process flow, lowering the production cost, further protecting a natural structure of the olesome, preventing surface oil from separating out from a product and improving the storage stability; refined oil is not used in the preparation process, so that fat in the product retains more vitamins, polyphenols, sterols and other natural lipid accompaniments having the biological activities; and in addition, the product further has a certain natural oil stock flavor. The preparation method of the present invention features simpleness, rapidness and a low cost, further prevents the stability of the olesome from being destroyed during extraction and washing, and thus has a wide application prospect in the food industry.

### BRIEF DESCRIPTION OF THE DRAWINGS

To describe a technical solution in embodiments of the present invention or in the prior art more clearly, a brief introduction to the accompanying drawings required for the description of the embodiments or the prior art will be provided below. Obviously, the accompanying drawings in the following description are merely embodiments of the present invention. Those of ordinary skill in the art would also derive other accompanying drawings from these accompanying drawings without making creative efforts.

FIG. 1 is a diagram of powdered oil prepared in embodiment 1 of the present invention;

FIG. 2 is a diagram of powdered oil prepared in embodiment 2 of the present invention;

FIG. 3 is a micrograph of a powdered oil emulsion prepared in embodiment 1 of the present invention; and

FIG. 4 is a micrograph of a powdered oil emulsion prepared in embodiment 2 of the present invention.

### DETAILED DESCRIPTION OF EMBODIMENTS

The technical solutions of the present invention will be clearly and completely described below with reference to the embodiments of the present invention. Apparently, the described examples are merely a part rather than all of the embodiments of the present invention. On the basis of the embodiments in the present invention, all the other embodiments obtained by a person skilled in the art without making creative efforts are all concluded in the protection scope of the present invention.

### Embodiment 1

Preparation of Powdered Oil Based on a Peanut Olesome Emulsion:

(1) Preparation of the peanut olesome emulsion: peanuts subjected to impurity removal and cleaning were soaked into deionized water for 6 h at a room temperature according to a solid-liquid ratio of 1:4 g/mL; a resultant was crushed with a pulping machine until a particle size was smaller than or equal to 0.5 mm to obtain peanut slurry; and residues in the slurry were filtered out with a gauze to prepare the peanut olesome emulsion.

(2) Addition of a wall material to the peanut olesome emulsion: a certain mass of maltodextrin was added to the peanut olesome emulsion prepared in step (1); and the peanut olesome emulsion kept being stirred to prevent the system from caking during adding, until a content of a dry matter in the system was 33 wt % finally.

(3) Preparation of powdered oil with spraying and drying: the peanut olesome emulsion, in which the wall material was added, in step (2) was stirred and homogenized with a colloid mill for 3 times, where a gap between a rotor and a stator of the colloid mill is 0.1 mm, and then a resultant was sprayed and dried with a centrifugal spray dryer; and an inlet air temperature is 140□, and an outlet air temperature is 75□.

### Embodiment 2

This embodiment is different from embodiment 1 in that the maltodextrin in step (2) is replaced with casein.

### Embodiment 3

This embodiment is different from embodiment 1 in that the peanuts are replaced with soybeans, a solid-liquid ratio for soaking is 1:6 g/mL, and a soaking time at a room temperature is h.

### Embodiment 4

This embodiment is different from embodiment 1 in that the peanuts are replaced with rapeseeds, a solid-liquid ratio for soaking is 1:6 g/mL, and a soaking time at a room temperature is h.

### Embodiment 5

This embodiment is different from embodiment 1 in that the peanuts are replaced with rice bran.

### Embodiment 6

This embodiment is different from embodiment 1 in that the peanuts are replaced with micro algae.

### Embodiment 7

This embodiment is different from embodiment 1 in that the maltodextrin is replaced with gelatin, and a content of a dry mass in the system is 25 wt %.

### Embodiment 8

This embodiment is different from embodiment 1 in that homogenizing with the colloid mill is replaced with shear homogenizing; a rotating speed is 8000 rpm; and a homogenizing time is 15 min.

### Embodiment 9

This embodiment is different from embodiment 1 in that homogenizing with the colloid mill is replaced with high-pressure homogenizing; a pressure for homogenizing is 300 bar; and the number of cycles is 3.

### Embodiment 11

This embodiment is different from embodiment 1 in that the solid-liquid ratio in step (1) is 1:8 g/mL.

### Embodiment 12

This embodiment is different from embodiment 1 in that a content of a dry mass in step (2) is 45 wt %.

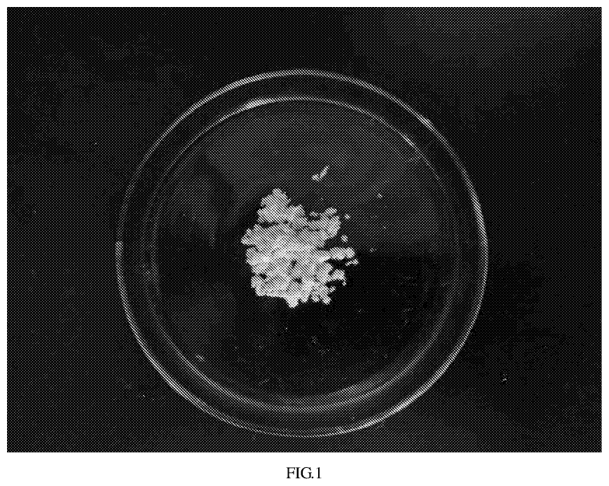

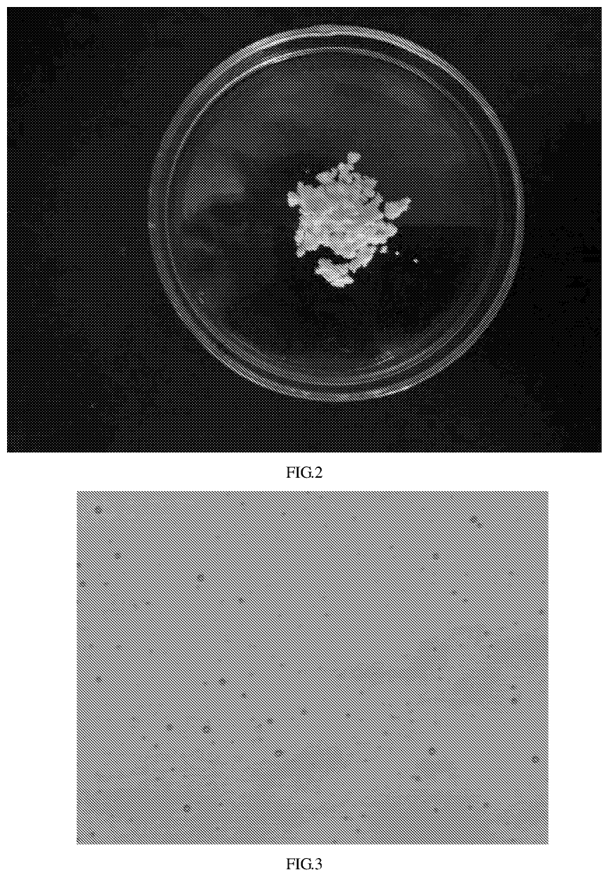

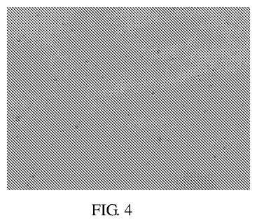

The powdered oil products prepared in embodiment 1 and embodiment 2 are subjected to sensory evaluation; the deionized water is added to powdered oil products for stirring and high-pressure homogenizing to prepare 0.5 wt % emulsions, and their microstructures are observed by optical microscopes; and particle sizes of the emulsions are determined with a laser particle analyzer. Results are shown in FIGS. 1-4 and the following table:

| | | | | Average |
|---|---|---|---|---|
| | Color | Smell | Texture | particle size |
| Embodiment | Milk white | Little peculiar light | Uniform and fine | 0.90 um |
| 1 | | flavor of peanuts | powder, easy flow, | |
| | | without peculiar | certain luster on | |
| | | smell | surface | |
| Embodiment | Milk white | Little peculiar light | Uniform and fine | 1.46 um |
| 2 | | flavor of peanuts | powder, relatively | |
| | | without peculiar | easy flow, weak | |
| | | smell | luster on surface | |

From the above test results, by using the method provided by the present invention, the powdered oil may be prepared conveniently and rapidly with a low cost; in the preparation process, the peanut olesome keeps stable in form and property without a deemulsification phenomenon; and the product is good in sensory property, has certain light flavor of the peanuts, and is uniform in distribution of particle sizes, good in dispersibility and good in comprehensive properties.

Each embodiment of the description is described in a progressive manner, each embodiment focuses on differences from other embodiments, and the same and similar parts between the embodiments may refer to each other. With regard to the apparatus disclosed in the embodiments, as corresponding to the methods disclosed in the embodiments, the systems are relatively simply described, and relevance may just refer to partial description of the method.

The above description of the disclosed embodiments enables those skilled in the art to achieve or use the present invention. Various modifications to the embodiments are readily apparent to those skilled in the art, and the general principles defined herein may be implemented in other embodiments without departing from the spirit or scope of the present invention. Therefore, the present disclosure will not be limited to the embodiments shown herein, but falls within the widest scope consistent with the principles and novel features disclosed herein.

What is claimed is:

1. A preparation method for powdered oil based on an olesome emusion, comprising the following steps:
(1) preparation of the olesome emulsion of an oil stock: soaking the oil stock subjected to impurity removal and cleaning into water according to a solid-liquid ratio of 1:(1-12) g/mL, and conducting crushing, pulping and residue removal with filtering to obtain the olesome emulsion of the oil stock;
(2) addition of a wall material in the olesome emulsion: adding the wall material to the olesome emulsion prepared in step (1) to make a mass ratio of the oil to the wall material in the system be 2:(1-18) and a content of a dry matter be 10-50 wt %; and
(3) preparation of powdered oil with spraying and drying: stirring and homogenizing the olesome emulsion, in which the wall material is added, in step (2), then conducting spraying and drying to prepare the powdered oil.

2. The preparation method for the powdered oil based on the olesome emusion according to claim 1, wherein the oil stock in step (1) is one or more of peanuts, soybeans, rapeseeds, sunflower seeds, sesames, linseeds, Camellia oleifera seeds, rice bran, walnuts, almonds and alga.

3. The preparation method for the powdered oil based on the olesome emusion according to claim 1, wherein a pulping fineness in step (1) is smaller than or equal to 0.5 mm.

4. The preparation method for the powdered oil based on the olesome emusion according to claim 1, wherein the wall material in step (2) is one or more of modified starch, maltodextrin, cyclodextrin, casein, a soy protein isolate, a whey protein, gelatin, Arabic gum and sodium alginate.

5. The preparation method for the powdered oil based on the olesome emusion according to claim 1, wherein the wall material in step (2) is dry powder, a solution, a paste or gel.

6. The preparation method for the powdered oil based on the olesome emusion according to claim 1, wherein the homogenizing used in step (3) is one or a combination of shear homogenizing, microfluidizing, homogenizing with a colloid mill or high-pressure homogenizing.

7. The preparation method for the powdered oil based on the olesome emusion according to claim 6, wherein a rotating speed for the shear homogenizing is 1000-11000 rpm, a pressure for microfluidizing is 100-2500 bar; a gap between a rotor and a stator of the colloid mill is 0.05-0.2 mm; and a pressure for the high-pressure homogenizing is 100-2500 bar.

8. The preparation method for the powdered oil based on the olesome emusion according to claim 1, wherein for spraying and drying in step (3), an inlet air temperature is 120-190□, and an outlet air temperature is 60-90□.
